(19) United States
(12) Patent Application Publication
(10) Pub. No.: US 2023/0277951 A1
(43) Pub. Date: Sep. 7, 2023

(54) Balloon

(71) Applicant: SEATRIEVER INTERNATIONAL HOLDINGS LIMITED, Northwich (GB)

(72) Inventor: James HALIBURTON, Northwich (GB)

(21) Appl. No.: 18/054,513

(22) Filed: Nov. 10, 2022

(30) Foreign Application Priority Data
Nov. 10, 2021 (GB) 2116161.7

(51) Int. Cl. F21V 3/02; B32B 3/08; B32B 27/32; B32B 27/30; B32B 27/36; B32B 27/08; B32B 7/04

(52) U.S. Cl. CPC F21V 3/026; B32B 3/08; B32B 27/32; B32B 27/306; B32B 27/36; B32B 27/08; B32B 7/04; B32B 2307/518; B32B 2250/24; B32B 2255/10; B32B 2255/28

(57) ABSTRACT

A balloon 1 comprising two sheets 2. The sheets 2 form the body 3 of the balloon 1. The sheets 2 are heat sealed together in a continuous line adjacent to the edges of the sheets 2, leaving a gap forming the neck 4 of the balloon 1. Each sheet 2 of the balloon is formed from two layers of plastic 6 and a layer of ink 7. The layers of plastic 6 are the same type of plastic, such that the sheets are formed from one type of plastic. The layer of ink 7 is printed upon the internal surface of an outer layer 8, such that the layer of ink 7 sits between the outer layer 8 and an inner layer 9.

### CROSS REFERENCE TO RELATED APPLICATIONS

This application claims priority from GB Patent Application No. 2116161.7, filed Nov. 10, 2021, the contents of which are incorporated herein by reference in its entirety.

### TECHNICAL FIELD OF THE INVENTION

The present invention relates to a balloon. In particular, but not exclusively, the present invention relates to a foil style balloon.

### BACKGROUND TO THE INVENTION

Balloons formed of plastic instead of latex (particularly foil-style balloons typically formed of two sheets bonded together) are useful for when it is desired that balloons remain inflated for an extended period, since the body of the balloon is not porous.

Such balloons are made of sheets which form the body of the balloon, each sheet being a layer of nylon and a layer of polyethylene bonded together (or alternatively a layer of biaxially-oriented polyethylene terephthalate and a layer of polyethylene bonded together). The nylon layer (or biaxially-oriented polyethylene terephthalate layer) forms the outer layer of the balloon sheet, being hard enough to provide structural integrity to the balloon and to hold helium within the balloon for longer. The outer layer may or may not be metalised. Metalising the outer layer means the helium will be held within the balloon for even longer. The polyethylene forms the relatively soft inner layer of the balloon sheet, that it is suitable for being easily heat sealed to the inner layer of the other sheet to form the body of the balloon. Such balloons have the disadvantage of being difficult to recycle given the multiple types of plastic within the balloon which are hard to separate and therefore not accepted by domestic or standard retail recycling facilities. As such they fill landfill sites, which is not a sustainable solution, or even end up littering the environment. Such plastic products are a particular threat to marine life if they end up in oceans.

Embodiments of the present invention seek to overcome/ameliorate these or other disadvantages and provide an improved balloon.

### SUMMARY OF THE INVENTION

According to a first aspect of the present invention there is provided a balloon comprising one or more sheets forming a body of the balloon, wherein the or each sheet is formed from only one type of plastic, and the or each sheet comprises a layer of the plastic and a layer of ink printed on the layer of the plastic.

It has been found that applying a layer of ink to a layer of plastic hardens the layer of plastic, such that the layer of plastic can be of a type suitable for heating sealing as well. This allows the body of the balloon to be formed from one type of plastic (to be mono-plastic), while still having both structural integrity and being relatively easy to heat seal. That the body of the balloon is formed of a single type of plastic means it is easier to recycle, making the balloon more environmentally friendly.

The or each sheet may comprise two layers of plastic, an inner layer and an outer layer. The outer layer may form an external surface of the body of the balloon. The inner layer may form an internal surface of the body of the balloon. The ink layer may be printed on the outer layer. The ink layer may sit between the outer and inner layers. The ink layer may be printed on a face of the outer layer facing the inner layer. The ink layer may be in contact with the outer layer and the inner layer.

The ink layer may be printed on a face of the outer layer facing away from the inner layer. The or each sheet may comprise a protective layer, covering the ink layer. The protective layer may comprise varnish or lacquer. The protective layer may consist of varnish or lacquer.

The ink layer may be printed on an external surface layer or layers.

Each sheet comprising two layers of plastic has the advantage that one layer can be hardened while the other is used for heat sealing. This minimises the chances of the hardening (due to the application of the layer of ink) interfering with the heat sealing, or the heat sealing impacting the layer of ink.

The layers of plastic of the or each sheet may be bonded together. The layers of plastic of the or each sheet may be laminated together. The layers of plastic of the or each sheet may be heat laminated together. The layers of plastic of the or each sheet may be bonded by an adhesive.

The inner layer may be thicker than the outer layer. Alternatively, the outer layer may be thicker than the inner layer.

The outer layer may be translucent. The outer layer may be transparent. The inner layer may be translucent. The inner layer may be transparent. The or each layer of plastic may be translucent. The or each layer of plastic may be transparent.

The balloon may comprise a plurality of sheets. The sheets of the balloon may be connected together to form the body. The sheets of the balloon may be bonded together. The sheets of the balloon may be sealed together. The sheets of the balloon may be heat sealed together. The inner layers of the sheets may be connected together to form the body. The sheets of the balloon may be connected together at or adjacent to their edges to form the body. The sheets of the balloon may be connected together continuously at or adjacent to their edges to form the body. There may be a gap in the continuous connection.

By heat sealing the sheets of the balloon a further material to form the seal (e.g. adhesive) is not required, making it easier to recycle the balloon.

The balloon may comprise a valve. The valve may be positioned in the gap. The valve may form an airtight seal within the gap, such that the only way for air to enter the balloon through the gap is through the valve. The balloon may comprise a neck. The neck may form the gap.

The valve may be formed from the plastic. The valve may be formed from only the one type of plastic.

The body of the balloon may be formed from only the one type of plastic. The balloon may be formed from only the one type of plastic.

The one type of plastic may be one of the following: polyethylene, polypropylene, polyvinyl alcohol, polylactic acid, or biaxially-oriented polyethylene terephthalate.

The balloon may be a foil style balloon.

The layer of ink may form one or more images. The layer of ink may form one or more artworks. The layer of ink may comprise a white wash. The white wash may be in contact with the outer layer. The layer of ink may comprise black blocking. The black blocking layer may be atop the white wash. the layer of ink may comprise one or more layers of colours of ink. The layers of colours of ink may be atop the black blocking layer. The layer of ink may be situated on a face of the layer of plastic. The layer of ink may cover the entirely of the face of the layer of plastic.

Each sheet may form approximately half of the body of the balloon. Each sheet may be circular. The or each sheet may comprise an internal surface and an external surface. The internal surface of the or each sheet may form the internal surface of the body. The external surface of the or each sheet may form the external surface of the body.

The balloon may comprise an illumination device operable to illuminate an internal space of the balloon. The illumination device may comprise an LED. The illumination device may comprise a power source. The power source may comprise a battery. The balloon may comprise a tab operable to be pulled out of the illumination device, thereby to turn the illumination device on. The illumination device may be positioned within the neck of the balloon. The tab may extend out of the balloon. The tab may extend out of an end of the neck of the balloon. The illumination device may comprise only the one type of plastic.

The or each sheet may be formed from only the layer or layers of the one type of plastic and the layer or layers of ink. The or each sheet may be formed from only one layer of the plastic and the layer or layers of ink. The or each sheet may be formed from the layer of layers of the plastic and only one layer of ink.

The outer layer may have a thickness between 0.016 mm-0.2 mm. The outer layer may have a thickness between 0.016 mm-0.15 mm. The outer layer may have a thickness between 0.022 mm-0.028 mm. The outer layer may have a thickness of 0.025 mm.

The inner layer may have a thickness between 0.016 mm-0.2 mm. The inner layer may have a thickness between 0.016 mm-0.15 mm. The inner layer may have a thickness between 0.022 mm-0.028 mm. The inner layer may have a thickness of 0.025 mm.

Each balloon sheet may have a thickness between 0.032 mm-0.4 mm. Each balloon sheet may have a thickness between 0.032 mm-0.3 mm. Each balloon sheet may have a thickness between 0.032 mm-0.15 mm. Each balloon sheet may have a thickness between 0.044 mm-0.056 mm. Each balloon sheet may have a thickness of 0.05 mm.

### DETAILED DESCRIPTION OF THE INVENTION

In order that the invention may be more clearly understood one or more embodiments thereof will now be described, by way of example only, with reference to the accompanying drawings, of which:

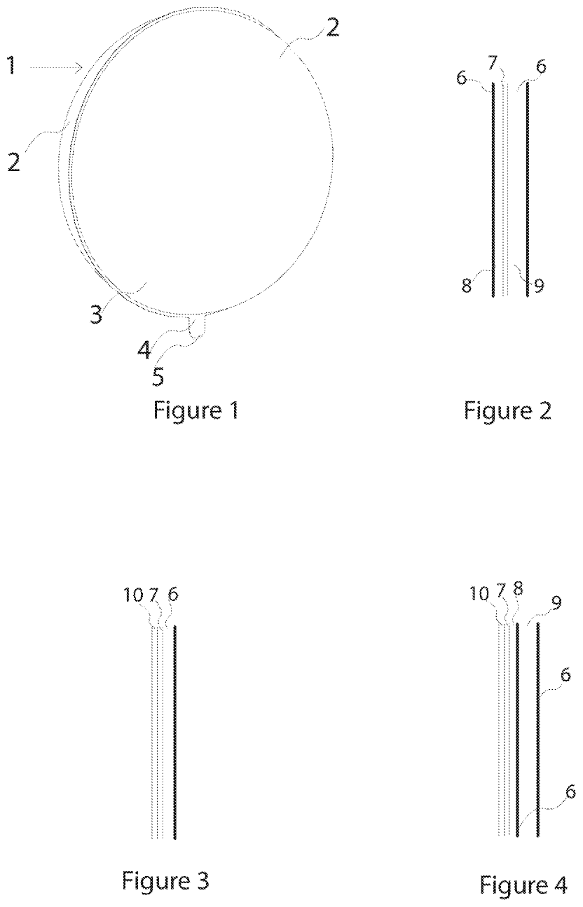

FIG. 1 shows a balloon;

FIG. 2 shows a section of a sheet for the balloon of FIG. 1;

FIG. 3 shows a section of an alternative sheet for the balloon of FIG. 1

FIG. 4 shows a section of a further alternative sheet for the balloon of FIG. 1.

As shown in FIG. 1, the balloon 1 comprises two sheets 2. The sheets 2 form the body 3 of the balloon 1. The sheets 2 are heat sealed together in a continuous line adjacent to the edges of the sheets 2, leaving a gap forming the neck 4 of the balloon 1.

An illumination device (not shown) sits within the neck 4 of the balloon 1. A tab 5 extends out of the balloon 1, extending out of the end of the neck 4. In use the tab 5 can be pulled out of the balloon 1 to turn on the illumination device.

A valve (not shown) also sits within the neck 4 of the balloon. The valve seals the neck 4 such that it is airtight, so that air can only enter the internal space of the balloon 1 through the neck 4 via the valve.

As shown in FIG. 2, each sheet 2 of the balloon 1 is formed from two layers of plastic 6 and a layer of ink 7. The layers of plastic 6 are the same type of plastic, such that the sheets are formed from one type of plastic. One layer of plastic 6 is an outer layer 8, the external surface of which forms the external surface of the balloon 1. The other layer of plastic 6 is an inner layer 9, the internal surface of which forms the internal surface of the balloon 1. The layer of ink 7 is printed upon an internal face of the outer layer 8, such that the layer of ink 7 sits between the outer layer 8 and the inner layer 9. The layer of ink 7 forms one or more images, and the layers of plastic 6 are transparent such that these images are visible when viewing the external surface of the balloon 1. The outer layer 8 is thinner than the inner layer 9. In the particular embodiment, the outer layer 8 has a thickness of 0.016 mm and the inner layer has a thickness of 0.025 mm.

To form each sheet 2, the layer of ink 7 is first printed on the outer layer 8 via gravure printing. The layer of ink 7 is formed from a white wash in contact with outer layer 8, a layer of black blocking atop the white wash, then one or more layers of colours of ink atop the layer of black blocking. The outer layer 8 is then laminated to the inner layer 9 to seal them together and form the sheet 2, with the ink layer 7 between the outer layer 8 and the inner layer 9.

The type of plastic of the layers of plastic 6 is polyethylene. In other similar embodiments, the type of plastic can instead be polypropylene or biaxially-oriented polyethylene terephthalate.

In an alternative embodiment, shown in FIG. 4, the layer of ink 7 is printed on the outer surface of the outer layer 8. A protective coating 10 is then applied to the layer of ink 7. The protective covering 10 covers the layer of ink 7, and consists of a varnish or a lacquer.

FIG. 3 shows an alternative embodiment, wherein each sheet 2 is formed on a single layer of plastic 6 and a layer of ink 7. The layer of ink 7 is printed on the external surface of the layer of plastic 6, and the layer of plastic 6 is heat sealed to the layer of plastic 6 of the other sheet 2 to form the body 3 of the balloon 1. In this embodiment the type of plastic is polyethylene, and the thickness of the sheet 2 is 0.05 mm. In other similar embodiments it can be polyvinyl alcohol, polylactic acid, or biaxially-oriented polyethylene terephthalate.

The one or more embodiments are described above by way of example only. Many variations are possible without departing from the scope of protection afforded by the appended claims.

1. A balloon comprising one or more sheets forming a body of the balloon, wherein the or each sheet is formed from only one type of plastic, and the or each sheet comprises a layer of the plastic and a layer of ink printed on the layer of the plastic.

2. A balloon according to claim 1, wherein the or each sheet comprises two layers of plastic, an inner layer and an outer layer.

3. A balloon according to either of claims 1 or 2, wherein the balloon comprises a plurality of sheets.

4. A balloon according to claim 3, wherein sheets of the balloon are heat sealed together.

5. A balloon according to any preceding claim, wherein the body of the balloon is formed from only the one type of plastic.

6. A balloon according to claim 5, wherein the balloon is formed from only the one type of plastic.

7. A balloon according to any preceding claim, wherein the one type of plastic is one of the following: polyethylene, polypropylene, polyvinyl alcohol, polylactic acid, or biaxially-oriented polyethylene terephthalate.

8. A balloon according to any preceding claim, wherein the balloon is a foil style balloon.

9. A balloon according to any preceding claim, wherein the layer of ink covers the entirely of a face of the layer of plastic.

10. A balloon according to any preceding claim, wherein the or each sheet comprises an internal surface and an external surface.

11. A balloon according to claim 10, wherein the internal surface of the or each sheet forms an internal surface of the body.

12. A balloon according to either of claims 10 or 11, wherein the external surface of the or each sheet forms the external surface of the body.

13. A balloon according to any preceding claim, comprising an illumination device operable to illuminate an internal space of the balloon.

14. A balloon according to any preceding claim wherein the or each sheet is formed from only the layer or layers of the one type of plastic and the layer or layers of ink.

15. A balloon according to claim 14 wherein the or each sheet is formed from only one layer of the plastic and the layer or layers of ink.

16. A balloon according to either of claims 14 or 15 wherein the or each sheet is formed from the layer of layers of the plastic and only one layer of ink.

17. A balloon according to any preceding claim comprising a valve.

18. A balloon according to claim 17 wherein the valve is formed from the plastic.

19. A balloon according to claim 18 wherein the valve is formed from only the one type of plastic.
